(19) United States
(12) Patent Application Publication
(10) Pub. No.: US 2006/0015450 A1
(43) Pub. Date: Jan. 19, 2006

(54) Financial services network and associated processes

(75) Inventors: Christopher D. Guck, Roseville, MN (US); Mark SB Tiggas, Eden Prairie, MN (US); Beverly J. Schwalbach, Lake Elmo, MN (US)

Correspondence Address: BAKER & MCKENZIE;PATENT DEPARTMENT, 2001 ROSS AVENUE, SUITE 2300, DALLAS, TX, 75201, US

(73) Assignee: Wells Fargo Bank, N.A., Sioux Falls, SD (US)

(21) Appl. No.: 10/890,495

(22) Filed: Jul. 13, 2004

(51) Int. Cl. G06Q 40/00

(52) U.S. Cl. 705/39; 705/43

(57) ABSTRACT

Disclosed herein are a financial services network and associated processes for providing interactive transmissions between network participants. The financial services network includes a private and secure transport network that allows for any number of financial services to be conducted between participants and other entities associated with the network. Each participant can operate as a requestor or responder. The system also includes a network administrator that is configured to govern the flow of messages directly between participants. By interconnecting participants to an unlimited number of information providers, all participants can obtain information and verifications on an interactive basis. Also, by employing a single network having a standardized message format and protocol, all participants can quickly and easily interactively request or provide information and verify to any other participant without the concern of incompatibility between system, transmission, or even message formats or protocols.

### TECHNICAL FIELD

Disclosed embodiments herein relate generally to a computer network architecture, and more particularly to a networked financial services system, for providing messaging between any number of network participants for any type of financial services, such as fraud mitigation, verification, and like services.

### BACKGROUND

Today, billions of coin and currency transactions occur between individuals and institutions every year. The extensive use of coin and currency transactions has limited the automation of individual transactions, such as purchases, fares, and bank account deposits and withdrawals. Unfortunately, however, individual cash transactions are burdened by the need to have cash on hand and by merchants having to provide change at the point-of-sale (POS). Furthermore, the handling and managing of paper cash and coins is inconvenient, costly, and time consuming for individuals, merchants, and financial institutions.

However, a major problem has developed with the continuous movement away from cash transactions—the fast verification of non-cash drafts or other transactions, as well as services available to mitigate the potential for fraud in financial transactions. As a result, merchants are increasingly insisting on payment and/or transaction guarantees from the financial institutions on which the draft is made, and financial institutions that are looking for improved fraud mitigation services. Conventional systems have continued to develop in an effort to provide services in all these respects. On the one hand, financial institutions want to provide guarantees to merchants and other financial institutions so that the transaction may take place expeditiously; however, on the other hand these institutions are eager to ensure that their payment or transaction guarantee is not improperly placed, lest they lose the cost of the transaction. Some reports estimate that each year $5 billion is lost in the United States alone due to uncollectible drafts. Of these, 41% of the losses appear to be due to closed accounts or fraudulent presentation (a draft was presented to a merchant or financial institution by a payee other than the account holder), and 55% of the losses appear to be due to non-sufficient funds (NSF), as well as other similar reasons.

Early attempts to curtail the acceptance of fraudulent or otherwise bad drafts has been, with regard to checks, to compare account information on the check with an accessible database having a list of known bad accounts or the like. Many of these systems even employ magnetic ink character recognition (MICR) readers to quickly obtain information from the check, and digitally transmit that information across a network, such as the public switched telephone network (PSTN), to compare the data with the information in the database. Unfortunately, such an approach typically involves a dedicated connection to the database, as well as individual fees associated with each verification. Moreover, since the database is often centralized at a third-party, the information contained may be old or even inaccurate. In addition, since the service is provided between only the merchant (or financial institution) and the third-party database, there is typically no way to verify that the database has received the specific information required from the proper party, for example, whether the database is updated with information from a particular bank on which the draft is drawn.

Another approach is the use of a third-party or outside guarantee service. With this approach, a service, or even the bank on which the draft is drawn, is asked to guarantee the funds in the transaction or perhaps the transaction itself. However, even this service often employs the same third-party databases in an attempt to verify funds and/or transactions within an acceptable risk of loss. Moreover, although a merchant may be protected by the guarantee of payment, the entity providing the service is not, due to fraud or simply non-sufficient funds, which typically results in the loss being distributed to a larger number of clients or the like as time passes.

To avoid such direct or distributed risks, a system and process is needed that provides the payee a guarantee of the transaction and/or funds at the POS, before goods are transferred or services (or currency if the payee is a bank) are rendered. More modern approaches have been recently implemented that provide a mechanism that allows a merchant to verify at the POS that the account on which a draft is drawn and presented to the payee is both a valid account and contains sufficient funds to cover the amount of the draft. Unfortunately, even these approaches suffer from several disadvantages, with perhaps the primary limitation being in the type of information or verification that can be obtained with these systems. For example, although an account may be verified as being in good standing and with plenty of funds, there is no verification available that the authorized person is the one presenting a draft on those funds. Thus, while both the merchant and the paying bank may be covered from loss, a loss would still occur, and that loss would likely again be distributed among a larger group over time.

Moreover, such systems typically provide a centralized processing location where all of the verification requests are sent, and which performs the verification itself. Such a centralized processing location may result in delayed responses due to a “bottle-necking” of all requests to a single location. In addition, the verification again typically relies on the central processing location to maintain accurate and up-to-date records of the required information, or at least have interactive access to the source of the needed information. Also, such reliance in a single, centralized processing location may quickly become painfully misplaced if interactive verification is needed at a time when the centralized system is down or otherwise unavailable. Accordingly, what is needed is a system and associated processes capable of providing interactive authentication and verification in financial transactions among an unlimited number of participants that does not suffer from the deficiencies associated with conventional approaches.

### BRIEF SUMMARY

Disclosed herein are a financial services network and related process for providing electronic, interactive transmissions between network participants for reasons such as fraud mitigation and guarantee services. The financial services network includes a private and secure digital information exchange network or “transport network.” The transport network allows for any number of financial services to be conducted between various merchants, financial institutions, and external providers of services to any and all participants in the transport network, where each participant in the transport network can operate as a requestor or a responder as each task requires.

In addition, the system also includes a network administrator that is configured to govern the flow of messages directly between participants in the transport network used to provide and obtain the various services. Specifically, the network administrator(s) provides and receives information to and from network integrators associated with the participants to govern communications between the integrators, however they need not receive the messages transmitted across the transport network. By interconnecting participants, such as merchants and financial institutions, to an unlimited number of information providers, such as public information offices or even other financial institutions, all participants in the network can obtain information and verifications on an interactive basis. Such processes allow for account and funds verification, as well as many other services to be provided by the network. This information could include, for example, the address of an account holder on which a draft is presented, the credit scores of a consumer, even fingerprint information capable of verifying the identity of a potential consumer, all obtainable on an interactive basis. By employing a single network having a standardized message format and protocol, all participants can quickly and easily request or provide information and verification services to any other participant without concern for incompatibility between message formats or protocols.

In one embodiment, the financial services network includes a transport network for the transmission of messages thereacross regarding services that may be beneficial to the completion of financial transactions. In addition, the financial services network includes a plurality of network integrators each connected to the transport network and configured to send and receive the messages across the transport network on behalf of entities connected to the transport network via their own corresponding internal interface adapter, where the network integrators employs standardized message and transmission formats and protocols for the generating, sending and receiving the messages. In such an embodiment, the financial services network further includes a network administrator connected to the transport network via one of the plurality of network integrators and configured to facilitate and govern the transmission of the messages across the transport network directly between the plurality of network integrators.

In another embodiment, the financial services network also includes a plurality of participant interface adapters, where each participant employing the network designs and implements one of these interface adapters to employ, for example, Web Services definitions for communicating with corresponding interfaces in its own network integrator. In this embodiment, each of the plurality of interface adapters is configured to translate requests or responses generated by its corresponding entity to the standardized message format, forward the translated requests or responses to its corresponding network integrator for generating a message based on the forwarded requests or responses, and receive requests or responses from its corresponding network integrator, where the received requests or responses are extracted from messages received by the corresponding network integrator across the transport network.

One embodiment of a network integrator that is providing a participant access to the transport network includes a message relay module configured to receive requests or responses from the participant, and to generate the message based on the request or response. In this embodiment, the network integrator further includes an administrative tasks module configured to determine a direct transmission path of the message to a second network integrator connected to the transport network. Also, the network integrator in this embodiment includes a message relay/receiver module configured to send the message to the second network integrator using message and transmission formats and protocols standard to the network integrators.

In a related embodiment of the network integrator, the integrator includes a relay/receiver module that is further configured to receive a message having requests or responses from a second participant sent via the second network integrator using message and transmission formats and protocols standard to all of the network integrators. In this embodiment, the network integrator also includes an administrative tasks module that is further configured to log receipt of the message, as well as a message relay module that is further configured to send the requests or responses in the message to the first participant.

Also disclosed is a method of communicating messages across a transport network. In one embodiment, the method includes receiving, at a first network integrator connected to the transport network, requests or responses from a first participant, where the requests or responses are regarding information and/or services typically associated with, for example, financial transactions, as well as generating a message based on the request or response with the first integrator. The method also includes determining with the first integrator a direct transmission path for the message to a second network integrator connected to the transport network, and transmitting the message to the second network integrator via the transport network using message and transmission formats and protocols standard to the network integrators. In such an embodiment, the method further includes receiving the message at the second network integrator, extracting the requests or responses from the message using the second network integrator, and sending the requests or responses to a second participant associated with the second network integrator.

In an embodiment related to such a method, the method further includes creating an intervening request by the second participant based on a received original request message from the first network integrator participant, where the original request message comprises an original request from the first participant, and then sending the intervening request to the second network integrator. This embodiment of the method also includes generating one or more intervening request messages based on the intervening request with the second network integrator, and transmitting the intervening request message to a third network integrator via the transport network using the standardized message and transmission formats and protocols. In addition, the method includes receiving an intervening response message at the second network integrator from the third network integrator, and extracting an intervening response from the intervening response message using the second network integrator, where the intervening response answers the intervening request. Furthermore, this embodiment of the method includes sending the intervening response to the second participant, where the second participant generates a final response to the original request from the first participant based on the intervening response and sends the final response to the second network integrator. Also, this method includes transmitting a final response message from the second network integrator to the first network integrator via the transport network using the standardized message and transmission formats and protocols, where the final response message comprises the final response answering the original request.

Further disclosed is a method of prioritizing the transmission of messages containing requests or responses regarding services that may be beneficial to financial transactions across a transport network. In this embodiment, the method includes providing a message containing an immediate request for information regarding a first financial transaction in need of an immediate response to the immediate request in order to be completed, as well as providing a message containing a nonimmediate request for information regarding a second financial transaction not in need of an immediate response to the nonimmediate request in order to be completed. The method then includes designating the immediate request and immediate response as high priority, and designating the nonimmediate request and nonimmediate response as low priority. In this embodiment, the method further includes transmitting the request and response designated high priority before transmitting the request and response designated low priority such that the first financial transaction is completed before the second transaction.

### BRIEF DESCRIPTION OF THE DRAWINGS

For a more complete understanding of this disclosure, and the advantages of the systems and methods herein, reference is now made to the following descriptions taken in conjunction with the accompanying drawings, in which:

FIG. 1 illustrates a block diagram of an exemplary embodiment of a financial services network providing an interconnection between any number of participants;

FIG. 2 illustrates the attaching and subtraction of data on message headers;

FIG. 3 illustrates a block diagram of an exemplary embodiment of a financial institution that is a participant in the financial services network discussed with reference to FIG. 1;

FIGS. 4A & 4B illustrate conceptual diagrams of integrators for use with a transport network such as the network discussed with respect to the financial services network of FIG. 1;

FIG. 5 illustrates a functional block diagram illustrating the flow of a request from a financial institution and a corresponding response from another participant across a transport network;

FIG. 6 illustrates a detailed block diagram of one embodiment of a financial services network discussed with reference to FIG. 5;

FIG. 7 illustrates an exemplary embodiment of a process flow within the exemplary financial services network shown in FIG. 6; and

FIG. 8 illustrates a sequence diagram showing various intervening requests from an original request sent by a first participant and a final response to that original request.

### DETAILED DESCRIPTION OF PREFERRED EMBODIMENTS

Networked Financial Services

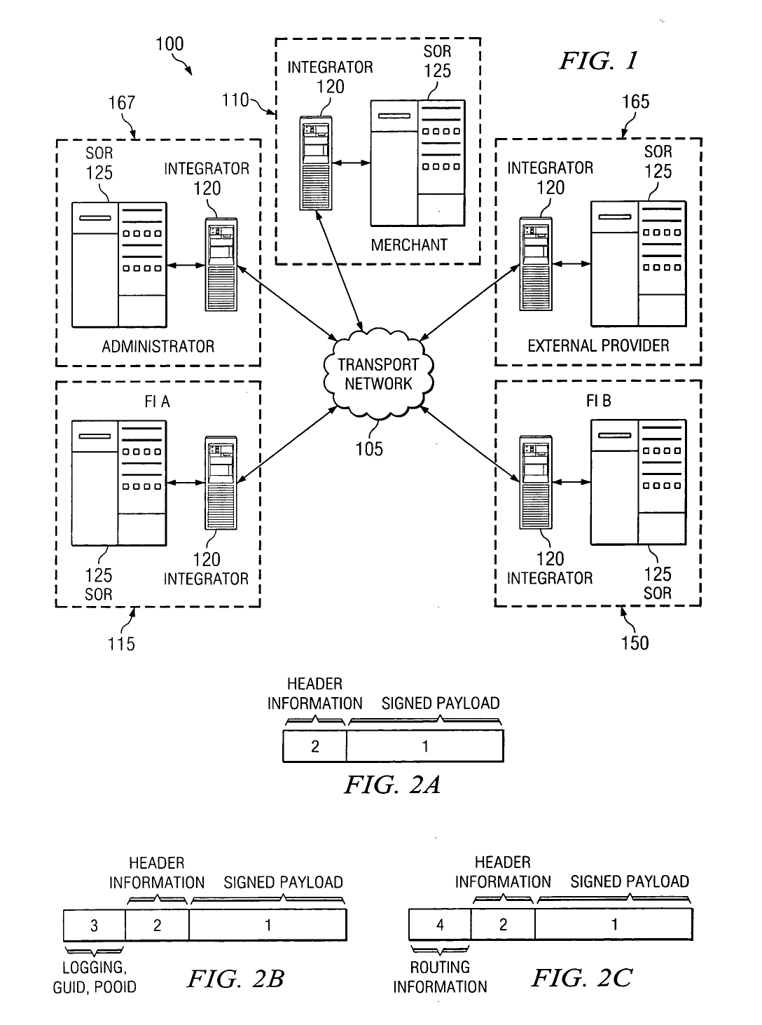

Referring initially to FIG. 1, illustrated is a high-level block diagram of an exemplary embodiment of a financial services network financial services network 100 providing an interconnection between any number of participants. The overall financial services network 100 includes a private and secure transport network 105. The transport network 105 provides an avenue for a number of selected services to be conducted between network participants, such as merchants 110, financial institutions 115, 150, and external providers 165 of services or information to the participants in the transport network 105. In addition, the financial services network 100 also includes a network administrator 167 that is configured to govern and monitor the flow of messages directly between participants in the transport network 105 that provide or obtain the various services or information.

The transmission of messages amongst participants takes place across the transport network 105. Each participant in the transport network 105 can operate as a requestor or a responder, as each task requires. Also, each participant could operate as both a requestor and responder in a single transaction, as described in more detail below. The various entities participate in the transport network 105 via network integrators 120 to form a collaborative financial services network. The integrators 120 are typically located at a participant's physical location and provide the boundary or gateway between a participant in the privatized transport network 105 and that participant's trusted and often specialized internal network. In one embodiment, the integrators 120 are embodied as network servers, however any type of hardware or other components may be used. Moreover, although illustrated as a single component connected to the transport network 105, the integrators 120 are a logical concept, and as such may be deployed as one or more physical nodes in the financial services network 100.

Typically, message transmission between participants of the entire transport network 105 operates in a standardized format, and thus in many such embodiments the integrators 120 do not provide any translation of messages from a participant's internal network to the format and protocols of the transport network 105. Instead, such format translations are provided internally by each participant's internal systems, as discussed in greater detail below, to a standardized format and message protocol employed by all participants. However, the transport formats and protocols employed by the integrators 120 to communicate across the network 105 are preferably unknown to the participants and other entities. As such, the integrators 120 may be configured to translate messages into a format or protocol used only between the integrators 120 during transmission, but any such translation would typically be invisible to the participants of the network 105. By standardizing formats/protocols between integrators 120, and by being unknown to the network participants, any or all of the integrators 120 may be altered, upgraded, or changed altogether by the network operator or administrators on an as needed basis without needing to consult any participants and without the risk that certain changes may be incompatible with certain participants' systems. Of course, if needed, the integrators 120 may provide a translation of message formats and system protocols from participant systems to the network standard to facilitate the desired services.

The systems of all of the participants in the transport network 105, in addition to the integrators 120, also include internal processing systems or components capable of housing “systems of record” (SORs) 125. The SORs 125 in each of the participants is typically embodied as one or more systems or modules that authoritatively provide a function for one of the participants on the transport network 105 or even for its own participant where it is housed. The SORs 125 implement a desired function/service after receiving a request through a message transmitted typically from another participant via an integrator 120. Exemplary functions provided by such an SOR 125 are discussed in further detail below.

The transport network 105 itself is typically a privately accessed Internet protocol (IP) network capable of handling message transmissions from any one entity to any other entity participating in the transport network 105. Additionally, the transport network 105 is embodied as a peer-to-peer network where the transport of messages directly between integrators 120 across the network 105 is governed and monitored by the administrator 167. The transport network 105 is designed to support interactive message (requests/responses) exchange (as opposed to bulk messaging) directly between participants. Since multiple entities will typically have points of presence on the transport network 105, each participant is ideally responsible for securing their connection to their integrator 120) and to ensure that the connection to their integrator 120 matches network security standards and data format(s) and protocols. Additionally, each participant is responsible for meeting or exceeding the operating standards that are governed and certified by the administrator 167 of the transport network 105.

To route messages from one participant to the intended receiving participant across the network 105, the integrators 120 typically employ routing tables and other information. Specifically, an integrator 120 determines the destination of a request message using the routing tables and then routes the message accordingly. In addition, during the transmission of messages (requests or responses) across the transport network 105, the administrator 167 does not actually receive the messages for any type of processing, as is done by many conventional systems and networks (e.g., switch networks). Specifically, the integrators 120 receive “flat files” from the administrator 167, typically at start up. The flat files may include, for example, the routing tables mentioned above, as well as other data/information used by integrators 120 to send messages to other integrators 120. As a result, messages are not forwarded on by the administrator 167; the administrator 167 simply governs the transmission of messages from one integrator 120 directly to another. Thus, when the requests (or responses) are transmitted between integrators 120, the specific payloads of the messages are not examined by the administrator 167 or the integrators 120. As a result, the transport network 105 can avoid potentially assuming some amount of liability for the veracity of guarantees or other types of responses provided in the messages. Moreover, not examining the content of the message payloads saves even more transmission time across the network 105.

When an interactive exchange of discrete messages between participants takes place (requests and corresponding responses), the exchange of messages may be bi-directional among participants. For example, if a first participant sends a request to a second participant, the second participant will send back a response to that request. However, the second participant may send a request to any other participant, or perhaps send a request of its own back to the first participant. Likewise, the first participant may be providing a response to a third participant that sent it a prior request. Moreover, this bi-directional interactive message exchange may be in regards to information pertaining to the same transaction or topic, or it may be regarding a completely different transaction or subject matter.

Messaging Techniques

Generally speaking, the messages transmitted across the transport network 105 are in a standardized request/response format, and will typically consist of synchronous request/response pairs. In addition, these message requests/responses are typically stateless, where any request/response pair is autonomous and independent of all other request/response pair, and only the requesting participants typically maintain workflow states. In a specific embodiment, the message transport protocol may be based on hypertext transport protocol (HTTP), while the message content may be based on a literal XML format, perhaps using an IFX domain model where practicable. Of course, any type of format or protocols for the messages may be employed to relay requests and responses to and from participants or even third party providers.

In an exemplary embodiment, the messages are sent via a Simple Object Access Protocol (SOAP) envelope over a 128-bit encrypted transport layer security (TLS) connection. The SOAP protocol defines a way to move XML messages from Point A to B, and contains a packet header and an XML document or data element as a payload. However, the message structure still follows centralized network standards (which are derived in part from common XML standards and formats) of the distributed financial system. In addition, Web Services definitions, or other similar messaging techniques, may be employed to help facilitate the transport of messages. Web Services are self-contained, self-describing, modular applications that can be published, located, and invoked across an IP network, and are well known in the pertinent field of art.

The specific structure of the messages will typically follow a specific structure that will be adhered to by all participants. All messages, regardless of purpose, will typically contain header information that identifies its destination, as well as containing global unique identifier (GUID) information to allow for logging of return and response times. The message structure may also allow for the actual message payload to be digitally signed, for example, using symmetric keys. Furthermore, as mentioned above, the integrators 120 may beneficially use flat file configuration files for lookups for routing messages, permissions, and the like during their transport across the network 105.

In one embodiment, delivery of a message is not guaranteed and failed message deliveries will not be resent. Instead, an exception process may be employed that creates an exception that will be noted, logged, communicated to the sender of the message, if appropriate, and communicated to the administrator 167, if appropriate. An exception is defined as an event during message processing that prevents the message from continuing normally, typically, an error or timeout (discussed in greater detail below) while waiting. In many embodiments, exceptions are logged when they occur and a message is sent to the appropriate entity for resolution. In addition, failsafe systems may be placed in the network integrators to route a message to another integrator if the primary path fails. Moreover, in a more specific embodiment, when an exception occurs, a determination may be made regarding whether that exception occurred due to failure of the particular service level agreement (SLA) involved in the transaction.

During message transport across the network 105, at the integrator 120 there may also be a specific flow sequence that includes adding and stripping information from the message header to accomplish certain functions. Specifically, throughout the transport process, blocks of information are typically added and subtracted to a requestor's message in order to provide quality of service (QOS) monitoring for message transport functions of: logging, routing, checking permissions, and tracking the path of the message. In the example illustrated in FIGS. 2A-2C, a Web Services application is invoked to send the request message and response message to and from integrators where additional data is added and subtracted. FIG. 2A illustrates a typical message package of information, which contains header information and the payload, which may be digitally signed for security. The header information of each package is what provides a type of “shipping label” for use in identifying the source and destination of the payload. As discussed herein, the payload is also not inspected by the network integrators as the messages traverse the network 105. FIG. 2B illustrates the same message packet after assembling logging, GUID, and point of origination identification data on the package during transport through the system. Finally, FIG. 2C illustrates the message packet with the logging, GUID, and point of origination identification data removed, and with routing information attached. In one embodiment, a message broker, perhaps embodied as a software application, may be employed in the system to perform such operations, as well as others, on the messages it receives. Example operations include header processing, security checks or encryption/decryption, message routing, error and exception handling, and header routing.

Header processing involves examining the header fields of incoming messages and performing some functions, while security checks and encryption/decryption involves security, authentication, and authorization. For one example, once it determines that the message contains data that can be used to authenticate, the message broker will authenticate messages against a security database. The message broker will also authorize operations that can be performed with this type of message. Message routing involves branching logic for delivering messages, and it typically occurs at two different levels for a message. First, header-level routing determines if an incoming message is bound for this application or needs to be resent to another application. Header routing determines to what integrator an incoming message is bound and which Web Service the message will invoke. Payload routing determines which procedure or method to invoke once the broker determines that the message is bound for this application message and an authorized participant. Error and exception handling occurs when the integrator responds to the client with an exception message, caused when the message sent to the broker does not contain sufficient or accurate information. Another cause for errors or exceptions could occur when servicing the request.

Also, in dialogues between participants the content of the messages is not limited to a single request or response. Thus, in some embodiments multiple requests may be transported in bulk to a certain participant. Furthermore, the content of network messages is not limited to simply requests and corresponding responses. More specifically, the content of transported messages may include information or data, such as files containing one or more images. As a result, not only may multiple requests/responses be included in a message, but also multiple image files or other types of data may be packaged in a single message for transmission to a participant. Still further examples of message content include various types of specialized payloads.

Message Prioritization

Due to the various types of content that may be transported in a message, the administrator 167 can institute a prioritizing of messages during a dialog between participants or even across the entire network for all participants. Such prioritizing may depend on, for example, the type of transaction, the type of request, the participant, the applicable SLA, or even the type of data file or information carried in the message. For example, in many transactions, the transfer of an image file is often done so for storing of the image file in an archive. Thus, the transport of such messages does not necessarily need to occur interactively, i.e., no customer or other participant is awaiting an interactive response/approval. As a result, a lower priority may be assigned to such a message when compared to an interactive request for, as an example, an immediate funds guarantee on a pending transaction having a check drawn for a large amount of money. Moreover, priority may also be established among messages pertaining to similar transactions, for example, priority given to a “preferred customer” when two or more requests for funds guarantees are simultaneously occurring from different participants.

Such prioritizing is another advantage provided by the transport network 105 or integrator 120, and the financial services network 100 as a whole, to more efficiently process the transfer of messages among participants and non-participants alike. In one embodiment, a multiple transfer, multi-protocol label switching application (MPLS) is employed to provide the message prioritizing. The MPLS approach calls for attaching labels on data packets (see FIGS. 2A-2C) being transported through the network 105. Specifically, once a request is generated and placed in proper message format for transmission on the network 105, the participant's integrator 120 sends the message onto the network 105. In one embodiment, it is the first router reached by the data packets comprising the message that attaches the label priority based on the label. Once the label is attached, all the routers across the network 105 give that message appropriate priority.

For the systems disclosed herein, network routers are typically configured to determine the fastest virtual path for each data packet of the message, so priority messages move even faster across the network 105. Thus, different paths may be used for delivering the exact same message during different times of the day. In a preferred embodiment, since all of the routers in the network 105 are supposed to give priority to that message, all of these routers are best kept under a central management, such as the network provider. By configuring the entire network (routers, integrators, etc.) to a centralized prioritization standard, network traffic may be more efficiently managed. For example, smaller bandwidth may be necessary for the entire network traffic through intelligent management of the network traffic flows.

Participant Interface Adapter & Associated Internal Participant Systems

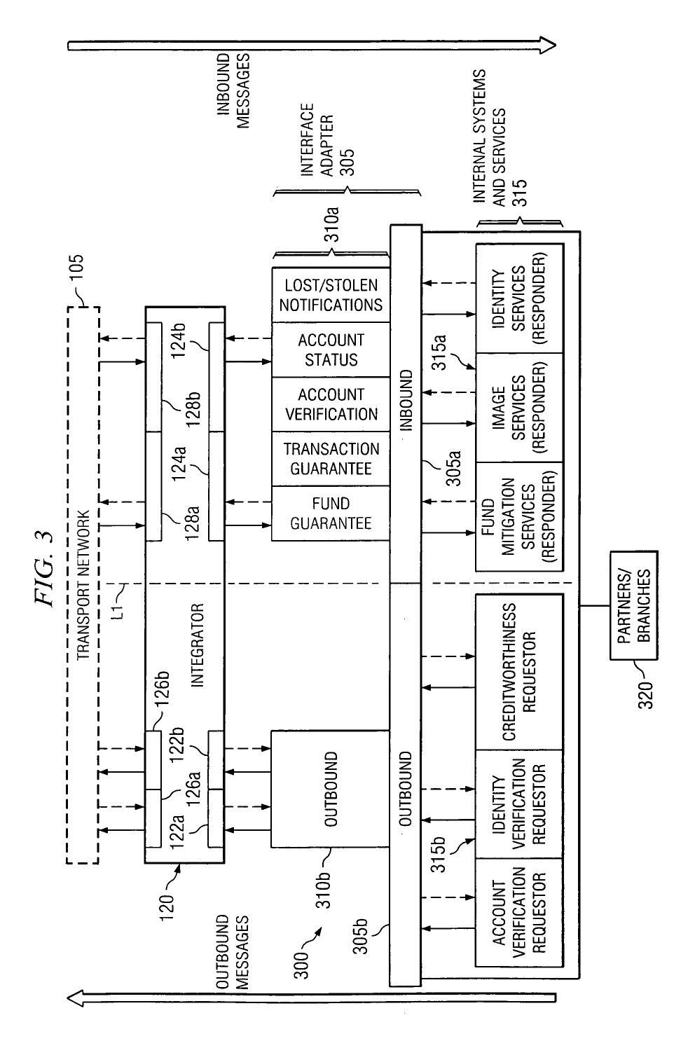

Turning now to FIG. 3, illustrated is a block diagram of an exemplary embodiment of a participant (e.g., a financial institution) 300 in the transport network 105 discuss with reference to FIG. 1. The financial institution 300 includes an internal interface adapter 305 for connecting the financial institution's 300 internal systems 315 and/or network to the transport network 105. An interface adapter like the illustrated interface adapter 305 in FIG. 3 is employed and configured by each participant in the transport network 105 to handle messages received from the transport network 105 or to be directed to another entity or participant on the network 105. For clarity of discussion, the participant 300 and associated integrator 120 are figuratively divided by line L1 into inbound and outbound sides. The outbound components handle the creation and transmission of requests originating at the participant 300, as well as the responses received from others for those requests. In contrast, the inbound components handle requests received from other participants, as well as the responses the participant 300 sends to those received requests. Of course, no structural limitation in any of the components and systems illustrated in FIG. 3 is intended by use of line L1.

Each participant in the transport network 105 builds their respective interface adapter to deal with each message possibility in a particular manner, but in accordance with the standard network specifications. More specifically, such personalized configuration may be different among any of the participants. Moreover, by allowing such personalization, a participant's interface adapter can be customized to work most efficiently with that participant's internal systems and private networks. In addition, however, the interface adapter 305 is further configured to interface with the integrator 120 employed by that participant to access the network 105 for the receipt and transmission of messages, as mentioned above, to and from other participants (who may then in turn use their own internal interface adapter and systems in a similar manner), and/or to invoke services for accessing external databases and other resources reachable by message via the transport network 105. However, each integrator typically handles messages transported on the network 105 in a standardized manner, and thus the interface adapter should be configured to translate formats and protocols to and from the integrators, regardless of any customization with the participant's internal systems or networks.

As mentioned above, the interface adapter 305 includes message handling and responding functions for formatting or translating messages between transport network 105 formats and protocols and those of the participant's internal processing systems 315. For such message handling there are a number of specific message handling parameters for dealing with inbound and outbound messages. During the configuration of the interface adapter 305, various such parameters are implemented by each participant in their specific interface adapter 305, and these parameters work with an integrator 120 to properly route inbound and outbound messages for that participant. Looking at FIG. 3, there are a number of interface service definitions regarding, for example, specific Web Services definitions 310a on the inbound interface adapter 305a. These examples include, but are not limited to, funds guarantee, transaction guarantee, account verification, account status, and lost/stolen notifications. Such service definitions 310a are visible to the inbound, inward facing interfaces (inbound relays 124a, 124b) of integrator 120 and are thus invoked by either the interactive request inbound relay 124a or bulk messaging inbound relay 124b on the integrator 120, depending on whether the inbound message is an interactive request or a bulk message. By invoking a particular service definition 310a on the inbound interface adapter 305a, the internal routing of requests is performed. For example, if a request is received by the interface adapter 305 in response to, for example, an information request originating from another participant, and the request is seeking a verification of the owner of an account on which a check has been presented to another participant, the proper service definition 310a at the inbound interface adapter 305a is invoked by the inbound interactive request relay 124a at the integrator 120 so that the message request is properly routed within the participant's system 315. Similarly, outbound interactive interface 122a and bulk messaging interface 122b at the integrator 120 are visible to the outbound channel 310b of the outbound interface adapter 305b for requests that originate at, and are sent by, the participant 300. In the illustrated embodiment, outbound and inbound requests are illustrated with solid arrows, while corresponding responses are shown in broken line.

The integrator 120 also includes outbound relays 126a, 126b (interactive and bulk messaging, respectively), as well as inbound receiving interfaces 128a, 128b. The outbound relays 126a, 126b are provided to relay outbound interactive and bulk messages across the network 105 that have been received from the outbound interface 305b via the outbound receiving interfaces 122a, 122b. The inbound relays 124a, 124b are provided to relay inbound messages (interactive messages and bulk messages, respectively) received by the integrator 120 from the network 105 via the inbound receiving interfaces 128a, 128b. These inbound requests are forwarded to the participant's 300 inbound interface 305a via the appropriate service definition 310a, as discussed above.

The internal processing systems 315 provide various processing functions within the participant 300 that function as “responders” 315a to provide responses to incoming requests, and may have several data systems and SORs that it employs to carry out various tasks. In addition, the internal systems may also include any number of “requestor systems” 315b for generating requests that invoke the services of other participants via the network 105. In the illustrated example, the participant is a financial institution, so examples of such responder systems 315a include fraud mitigation services, identity services, and services associated with processing images received. Illustrated examples of requestor systems 315b include account verification, identity verification, and status requesting functions. Of course, any type of internal processing system 315 may be present. In function, as financial institution 300 receives a request that, for example, requests that a fund guarantee be made on a check drawn from one of its own customer accounts, internal systems 315a may be employed to process the request by verifying the drawn account is in good standing, that there are sufficient funds in the account, and perhaps even verifying the identity of the check drafter.

Furthermore, if a request is made of financial institution 300 that cannot be processed entirely on its internal systems 315, these systems 315 may also be configured to determine the need for outside information or verification, and then generate a separate request, distinct from the original request it received, which may then be sent out over the transport network 105 to, for example, another financial institution participant. Such parallel requests are referred to as “intervening requests.” As used herein, the term “intervening request” means a request that is generated in reaction to receiving a request that is awaiting a response, where the intervening request is sent, typically unknown to the sender of the original request, to gather information on which to base a response to the original request. An “intervening response” is simply the corresponding response created to answer an intervening request, both of which are discussed in greater detail below. Moreover, these internal systems 315 may also be configured to work with affiliates of financial institution 300, such as business partners or even one of its own branch locations 320. For example, if a branch location 320 of financial institution 300 is presented a check and a verification is desired, a direct connection (e.g., via a private network) between this branch location 320 and financial institution 300 can allow the internal systems 315 to process the request as needed or desired.

Network Integrators

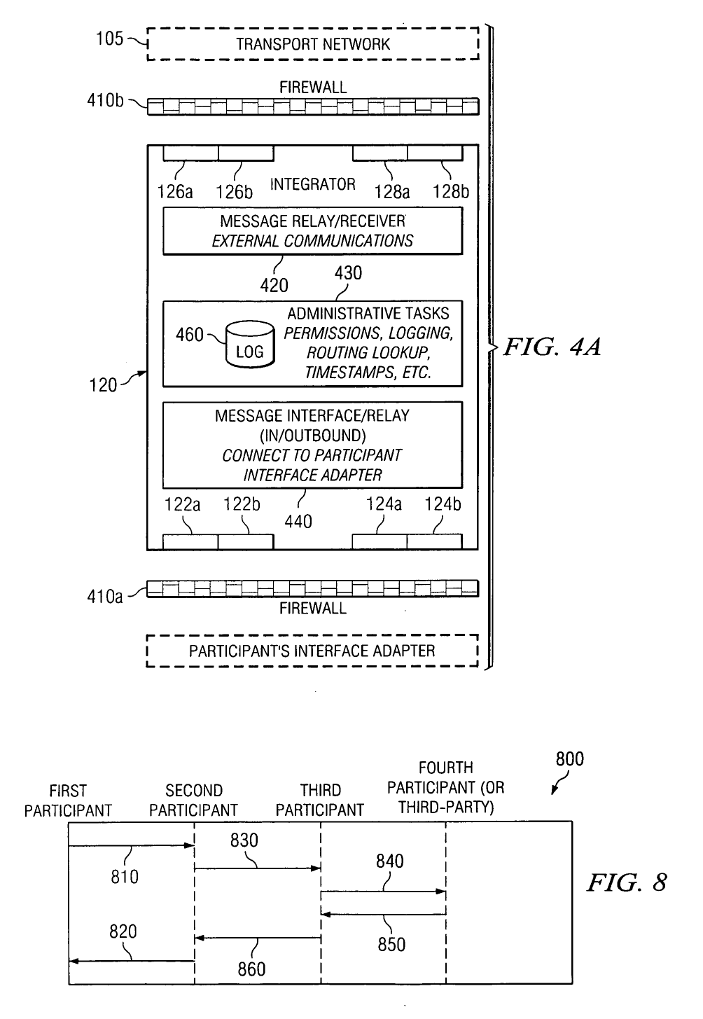

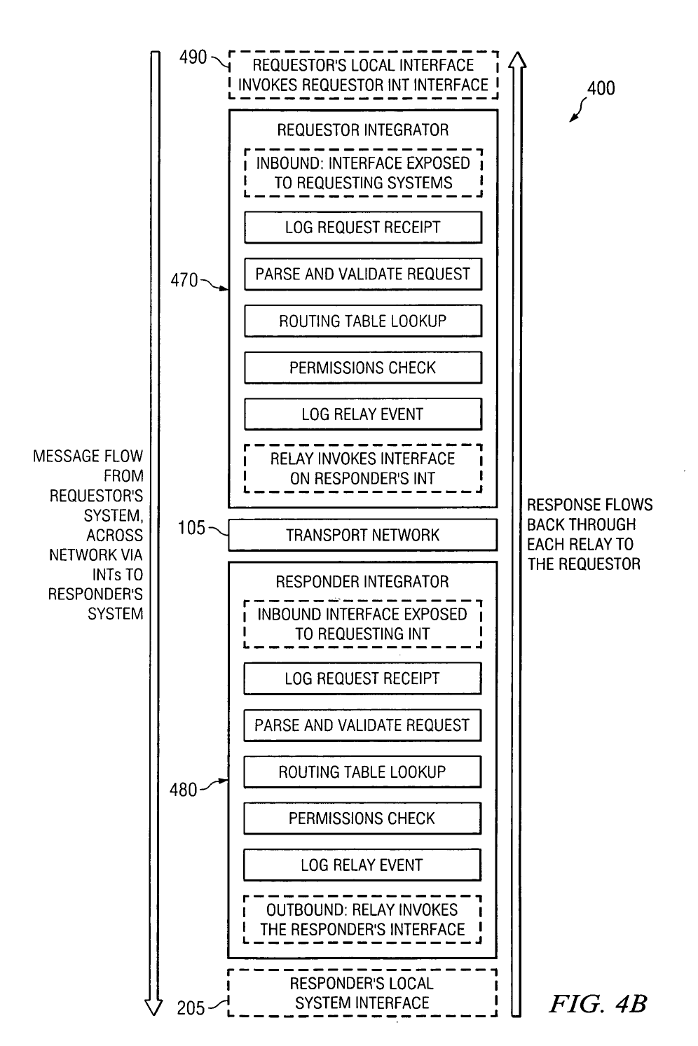

Turning now to FIGS. 4A and 4B, illustrated are conceptual diagrams of integrators for use with a transport network such as the network 105 discussed above. More specifically, FIG. 4A illustrates a detailed conceptual diagram of the functional components of a single integrator 120. FIG. 4B illustrates a functional diagram of the transmission of a message request between two integrators 470, 480 across a transport network 105.

Looking first at FIG. 4A, the integrator 120 is embodied as a computer network server capable of facilitating communication across a packet-based IP computer network, typically between firewalls 410a, 410b protecting it from both the participant's internal systems/networks and the external transport network 105. Of course, the integrator 120 is not limited to an IP network server configuration. In function, the integrator 120 serves as the “on-ramp” to the transport network 105 for participants in the network 105. In addition, the integrator 120 is configured to efficiently route message traffic in a peer-to-peer manner with another integrator connected to the transport network 105. Moreover, the integrator 120 monitors message flow, enforcing SLA rules and other rules regarding message transmission, and other administrative tasks. Some of the basic functionality provided by the integrator 120 includes security and access control, administrative logging, SLA enforcement, efficient routing, incoming/outgoing message administration, proactive QOS, and functioning as a messaging agent.

Looking at some of these possible functions more closely, security and access control involves the integrator 120 being an authentication point to the transport network 105, enforcing permissions for appropriate message use, and perhaps doing encryption/decryption, and serving as the gateway to get messages to or from the network 105. Administrative logging typically involves time stamping messages, the logging of activities for dispute resolution, proactive SLA monitoring, message transport, fee bookkeeping, and inter-participant usage capture reporting (see below). SLA enforcement has the integrator 120 monitoring SLA compliance of participants' systems interactively, flagging and sending alerts to the administrator 167 to take action on SLA or other service issues, and enforcing any type of business relationship agreement, such as permission checks.

Efficient routing involves providing a service for lookup of message destination for use in routing based on, for example, a routing transit number of a check. Incoming and outgoing message administration involves, for outgoing message requests, receiving a request for a service from an SOR (e.g., a teller system), opening a connection to the responder (e.g., a information provider), and then relaying the message to the responder's integrator. For responses to incoming requests, the integrator accepting the connection and request from the requestor's integrator, invoking services exposed by the responder to access SOR(s) to answer questions or provide information, and then relays a response from the SOR(s) back to the requestor's integrator. Functioning as a messaging agent typically involves Web Services exposure, specifically, providing access to message transport request services via Web Services, providing a relay mechanism to invoke business services at a participant's location via Web Services, and initiating message transport and monitoring completion of the transmission of the message. Finally, proactive QOS involves certain QOS measures, including monitoring and logging successes and failures of business processes, and sending alerts to expedite failure escalation. In many of these respects, the integrator 120 transmits logs and alerts across the network 105 to the administrator 167. The administrator 167 may then perform pattern analysis or the like on data received from the integrators 120 to perform such QOS services.

As shown in FIG. 4A, the integrator 120 includes a number of internal modules to provide the functionality discussed above. For example, the integrator 120 includes a message relay/receiver 420, a module for performing administrative tasks 430, and a message interface/relay module 440. The message relay/receiver 420 is associated with the outbound relays 126a, 126b and inbound receiving interfaces 128a, 128b for sending and receiving messages to and from, respectively, the transport network 105, as discussed above with reference to FIG. 3. The message interface/relay module 440 is associated with the outbound receiving interfaces 122a, 122b and inbound relays 124a, 124b for receiving and sending messages from and to, respectively, a participant's interface adapter, also as discussed above.

Depending on the whether the integrator 120 is receiving or transmitting messages, the different modules in the integrator 120 provide different facets of the message handling functions. Thus, if the integrator 120 receives a request from the network 105 via the inbound receiving interfaces 128a, 128b, the relay/receiver 420 accepts the message and the administrative tasks module 430 may then log information about the inbound request. The inbound relays 124a, 124b (which one depends again on whether it is an interactive request or a bulk message) then forwards the request on to the participant by invoking the appropriate service definition 310a of the participant's interface adapter 305 (see FIG. 3). Similarly, if the integrator 120 receives a request from the participant via the outbound receiving interfaces 122a, 122b, the message interface/relay module 440 accepts the message and the administrative tasks module 430 may also log information about the outbound request. The outbound relays 126a, 126b (which one again depends on whether it is an interactive request or a bulk message) then relays the request across the network 105 to another integrator using the message relay/receiver module 420. Other message handling functions performed by the integrator 120 include, but are not limited to, message header parsing and validation, logging at various steps, routing lookup, and permissions check. In addition, the message handling function employs the modules in a slightly different manner when a response is sent back to the requesting entity, or an original request is created.

As messages are received by the integrator 120, either going to or coming from the participant, message payloads are not necessarily inspected, primarily for reasons of privacy but also for maintaining performance efficiency and throughput. Since the message handling functions collectively have responsibility for eventual response back to the requesting entity, there is therefore an opportunity for the integrator 120 to collaborate with the administrator 167 to create logs 460 based on message transmissions, and transmitting those logs to the administrator 167 for analysis, as mentioned above. For example, if a lack of compliance with an SLA is identified by the tasks module 430, it can terminate a request and return control back to the requesting system while sending an alert message to the administrator 167 regarding the error. Such lack of compliance may be determined using the logs 460 captured at the integrator 120 (stored in a database or other storage device) by the administrative tasks module 430 for forwarding to the administrator 167.

As messages pass through the integrator 120, several pieces of information may be stored in the logs 460. For example, the header of an incoming message may be inspected and the header contents validated. Such functions may be performed regardless of the direction of message flow. Such message parsing functions ensure that a well-formed request is present. For example, if a given service requires values and values are not received, it is expected in most circumstances that the request would be rejected. The event will be logged in the log 460 and sufficient return codes may be set to alert the requestor of the condition. Patterns in entries in the log 460 will determine the action, if appropriate, as sensed by log monitoring/alert subsystems in the administrative tasks module 430. Such subsystems will typically vary with toolset and techniques employed in developing and operating the overall network 105. Moreover, the integrator 120 will typically capture both business and technical activity in a local log file and then later send those logged files to an administration site, for example, at the administrator 167, for analysis. These local log files may be transmitted as such in a typical store-and-forward fashion, even while message processing continues. Exemplary methods for transporting log files to network administration servers/sites include Secure FTP, Connect:Direct (NDM), or another functional equivalent.

Turning to FIG. 4B, an example of the process of sending a message from a Requestor's integrator 470 to a Receiver's integrator 480. To this end, the functional modules that participate in sending a message via the transport network 105 are substantially similar on both ends of a request-response pair, since both integrators 470, 480 involved generally perform a “message relay.” However, before an integrator is ready for operation, there may be certain procedures that it executes for proper operation (e.g., “boot strapping” procedures). To this end, configuration files will typically be maintained for each integrator on administrative servers (e.g., administrator 167). Thus, each integrator may read a local file at startup to determine what server it should connect to for bootstrap processing. Each integrator may then authenticate itself to an administrative server and then typically retrieve a configuration file from the administrative server before exchanging data with other integrators.

Based on its configuration file, the integrator may download any mandatory or recommended files needed for operation before integrator-to-integrator communication commences. Beneficially, such configuration files may be pulled from administrative servers using a method/technique other than that used for normal integrator-to-integrator communication, for example, Secure FTP, Connect:Direct (NDM), or another functional equivalent. Examples of configuration files include, but are not limited to, routing tables, permissions tables, and messages tables, any of which may employ a flat file format. In addition, all integrator bootstrap events may be logged in the activity log files 460, including file downloads, implementation of files, etc., and once bootstrapping has completed, the activity log may be cycled. Any logging associated with bootstrapping will be in addition to any logging for typical message-based activities.

Once the integrators 470, 480 are ready for message transmission, the requesting participant's SOR invokes his system's own local interface adapter 490, which in this example is a Web Services based application. The interface adapter 490 then invokes the requestor's integrator 470. The requestor's integrator 470 receives the request, logs receipt of the request, parses and validates the request, performs a routing table look-up to resolve the appropriate destination, performs a permissions check to determine whether there is a business relationship that permits the message to be processed, logs the relay of the message, and then invokes an interface of a destination integrator, which in this example is the intended responder's integrator 480. It should be noted that this flow is illustrated without “exception” processing. At any point along the message path, there is a possible: failure to connect, failure to successfully send, timeout pursuant to SLA, failure to receive any response at all, etc. In any or all these examples, the requestor's integrator 470 may then discard a request and return an error indicator. In addition, incorrect/improper requests may be rejected at any point of detection, and each “invoking point” (a point that invokes processing (e.g., via a Web Services service definition) by another component associated with the transport network 105) affords the ability to measure SLAs. As each participant develops their own unique logic with which to connect to their integrator (e.g., via their interface adapter), the number of systems impacted by, for example, an interface change, can be reduced.

After the requestor's integrator 470 transmits the message across the transport network 105, it is received at the intended responder's integrator 480. The responder's integrator 480 then typically logs receipt of the request, as well as validates that the request is proper and parsing it for delivery to the appropriate destination. Depending on the type of message received by the responder's integrator 480, it may have to go through different processes to identify the appropriate final intended destination (e.g., the responder's interface adapter/system, or even perhaps just the integrator 480 itself). This lookup functionality allows the overall system to support many types of messages, rather than only participant-to-participant requests/responses. In one example, a check's Routing Transit Number (RTN) gathered from the check MICR data in a prior process at the requestor's system may provided the lookup information needed to properly route the request. However, if service is offered via the network 105 to fetch an image of an item on request, the routing table lookup could use the identification information of the archive containing the image, as well as the pass retrieval keys to the archive. It would then forward the appropriate message to the service providing the retrieval.

After the routing table lookup is complete, a permissions check is typically performed by the message handling modules of the integrator 480 to determine whether the incoming message is expected (allowed) from the requestor and whether the intended recipient should (is allowed) to receive that type of message from the originator. This processing step could be accomplished with a lookup against a memory array that caches the unique combinations of requester, responder and message (service) type. One benefit to such a permissions check is to help thwart attempts to spoof service requests. Integrators receive a message from a requester and then relay that message to an exposed interface adapter. The final step of relaying the message is managed by the message relay module 440 (see FIG. 4A), which typically has the various formats available for messages that are expected by the responder integrator 480. More specifically, for a message received from one participant's interface adapter, the relay module 440 may reformat the message, if necessary, and invoke the interface on another integrator if the relay is to another participant. If the message is received from another participant's integrator, the relay module 440 invokes the service definitions at the responder's interface adapter for processing the message and its format. In other embodiments, such format processing may be done at each participant's internal systems, which may allow all facets of the integrators to function using only one format.

During the processing of requests or responses in an integrator, that integrator's log monitor and alert subsystem within its administrative tasks module 430 has responsibility for detecting problems and escalating issues to support personnel of the network 105 via, for example, the administrator 167. In a specific embodiment, events and conditions may be monitored and logged into the activity log 460 for use in statistically comparing entries against established expectations. For example, if N percent of messages within N minutes or seconds fail to receive a response, an appropriate alert may be generated and sent to the active administrative server(s) to indicate there is a significant or persistent problem. Another example of an exception would be if the messages were not meeting the responder's SLA, or that the subsystem detects that the network performance is below SLA. Regardless of the cause, the sending of alerts should ideally not exacerbate any problems, for example, detected failures in meeting SLA should not flood the network 105 with alerts and thus compete with the transmission of service messages.

In addition, parameters may also be setup for the integrators 120 and maintained at the administrator 167. As mentioned above, such parameters may then be downloaded to the integrators 120 for use in transmitting messages. The administrator 167 may then do pattern analysis on message transmissions (via information in stored logs) to detect problems, if desired. One example of a specialized rule that may be established by a participant or the administrator 167 is when a participating entity establishes the maximum wait time for receiving a response to a transmitted request. When that maximum time is reached, exemplary rules may then require that the transaction is denied. Alternatively, the requestor may simply continue to wait for a response past the maximum allotted time, and then, although the information is eventually received, take this nonconformance into consideration when the net balance of requests between the two participants is accounted. In yet another embodiment, a second request message may be sent to the responder. In one embodiment, no confirmation that the request message was received is employed in the system, so as to save transmission and processing time, although such confirmations are possible. Timeout rules, such as those just mentioned, may be useful in applications when there is a lack of confirmation in the service (e.g., when no response is received). By employing such time-out rules, rather than confirmations, the disclosed network and processes differ from a “switch” network environment. In a switch-type network, the receipt (or perhaps the loss) of the message is confirmed back to the original requester. As a result, the speed in transmission of the messages may suffer in such conventional switch-type approaches.

Communication Between Network Participants

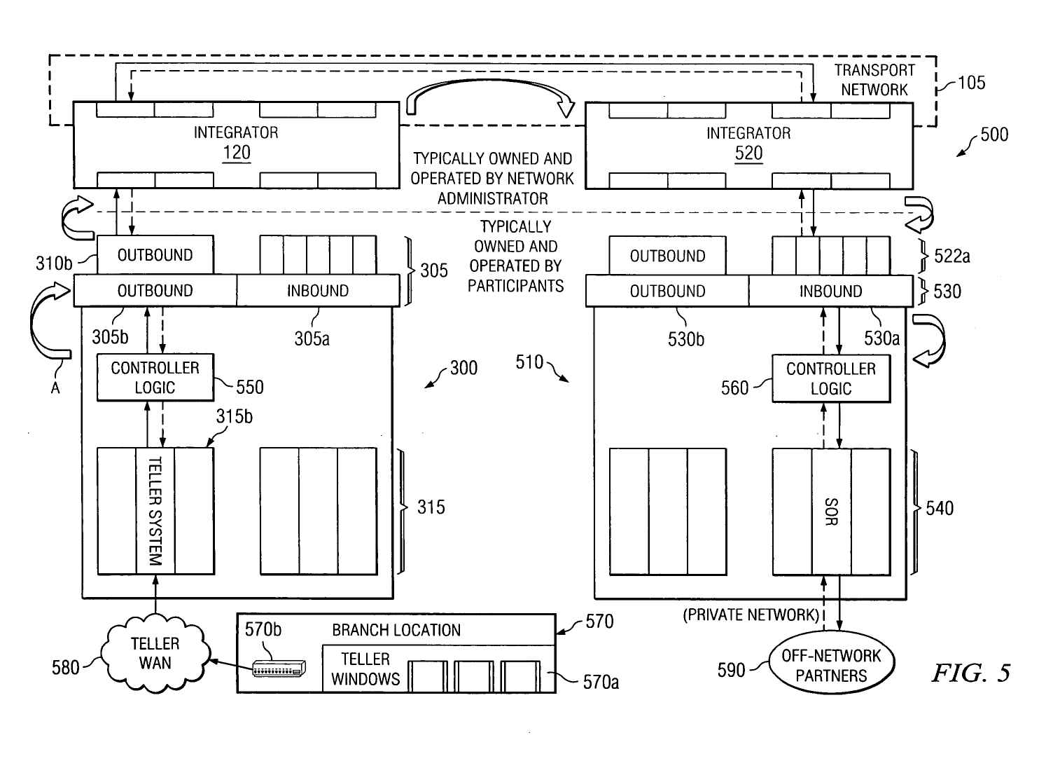

Looking now at FIG. 5, illustrated is a functional block diagram 500 illustrating the flow of a request and corresponding response from financial institution 300 shown in FIG. 3 and another participant 510 across the transport network 105. In this example, financial institution 300 is considered to be a first bank (Bank or FI 300), while the second participant is considered to be a second bank (Bank or FI 510). More specifically, the example includes a bank teller system at Bank 300 that is requesting verification from Bank 510 about a check presented at Bank 300 that is drawn on Bank 510.

As shown, Bank 300 is employing integrator 120, while Bank 510 is employing a separate integrator 520 at it own location. Both of the integrators 120, 520 are embodied as multifunction network servers connected to the transport network 105, in accordance with integrators discussed above, however separate send and receive functions may also be embodied in multiple corresponding physical servers. Moreover, the systems in both Bank 300 and Bank 510 each include a single centralized interface adapter (305 and 530, respectively). These interface adapters 305, 530 are typically separated as a portion for inbound messages 305a, 530a and a portion for outbound messages 305b, 530b. As mentioned above, these interface adapters 305, 530 provide the junction between the internal, specialized systems or SORs (315, 540) of both Bank 300 and Bank 510 with the standardized format and protocol of the integrators 120, 520 connected to the transport network 105. Of course, any participant may construct and customize its own interface adapter to suit its own internal needs, such as security, internal messaging protocols, etc. However, the external standards of a participant's interface adapter (facing the integrator) still conform to those of the transport network 105, as discussed above.

The two Banks 300, 510 in this example also include internal controller logic (550, 560) for processing requests and responses between the interface adapters 305, 530 and each Bank's 300, 510 internal systems 315, 540. Still further, Bank 300 is illustrated connected to one of its branch locations 570 via a multipurpose Wide Area Network (WAN) 580. The check presented for cashing in this example is being presented at the branch location 570 through typical teller windows 570a, which communicate with the Bank 300 via the Teller WAN 580. Also, Bank 510 is shown connected to its off-network partners/affiliates 590 that are not participants in the network 105. These partners 590 may be accessed via a private network or otherwise contacted by Bank 510 as third-party providers of information or the like, if desired.

The process begins with the check drawn on Bank 510 being presented for cashing at the teller windows 570a of Bank 300. Since banks typically engage in some type of verification for checks, the MICR numbers are read from the face of the check via an MICR reader 570b for use in verifying the status of the account and obtaining a guarantee of the funds for the check. The MICR information is transmitted via the teller WAN 580 to the internal verification systems 315 of Bank 300. However, since the check is drawn on a different bank, further information is needed to make the desired verification(s). Thus, the controller logic 550, in accordance with the teller requestor system 315b, invokes the outbound interface adapter 305b to send a request across the network 105 to gather the information. In the illustrated embodiment, the request is shown by solid arrows, while the response is shown in broken line. The controller logic 550 additionally ensures that the request has been placed in the appropriate standardized format used by the integrators 120, 520 on the network 105. The outbound interface adapter 305b then invokes integrator 120 via an outbound channel 310b to send the request to Bank 510 across the network 105. Integrator 120 thus invokes integrator 520 at the location of Bank 510 for the response to the request. In this figure, each point where an interface is invoked by an outgoing request (e.g., from integrator 120 to integrator 520) is illustrated by a broad arrow, one of which is labeled “A”. However, while several components/systems are invoked in order to send an outbound request, a response to that request is typically transmitted back to the requestor via open connections between each component back to the awaiting integrator 120, and thus does not usually invoke an interface at each step of the return path. Of course, open, waiting connections are only one embodiment of the disclosed financial services network and processes, and new connections invoked for both requests and responses are possible.

When the request message is received at Bank 510, its integrator 520 invokes its inbound interface adapter 530a, which receives requests and invokes appropriate system(s) 540 (e.g., SORs) to formulate a response to the request in the message. Specifically, the controller logic 560 of Bank 510 receives the request from the inbound interface adapter 530a and may convert it to a format, if necessary, that can be processed by the internal systems 540 of Bank 510. In this example, if a request is for verifying the status and funds in the account on which the check is drawn, the appropriate SORs 540 relating to, for example, account verification is employed to verify the status and amount of funds in the account, as requested, and provide that information in a response back to Bank 300.

Once an affirmative or negative answer to the request has been determined by Bank 510, the controller logic 560 assembles the answer into a response to the relayed request. Alternatively, controller logic 560 may receive an assembled response having the answer. The inbound interface adapter 530a of Bank 510 then provides the response back to integrator 520 via the same service definition and using the predetermined standardized format and protocol of the network 105. In this embodiment, the response is passed back through the inbound interface adapter 530a that received the relayed request since it is an open connection back to integrator 520, which has an open connection back to integrator 120, which in turn has an open connection back to the outbound interface adapter 305b at Bank 300. Thus, in this embodiment, the outbound interface adapter 530b of Bank 510 is only used when an original request is generated by the SORs 540 for relaying across the network 105. The same holds true for the inbound 305a and outbound 305b interface adapters of integrator 120. When received at the integrator 520, integrator 520 then relays the response across the transport network 105 to integrator 120, also typically via an open, waiting connection as mentioned above. Integrator 120 receives the incoming response message and relays the response to the outbound interface adapter 305b of Bank 300, which is kept open and awaits a response to the original request. In this example, the response passes to the controller logic 550, and eventually to the teller requestor system 315b. This system 315b may then provide instructions or other type of information back to the teller at the branch location 570. The bank teller can then accept, reject, hold, etc. the check as instructed by her system, which has taken this response into account when making a final decision.

By providing integrators, such as the ones described with reference to FIGS. 4A, 4B, and 5, several advantages over conventional financial networks are provided. For example, the use of integrators by all participants in the network 105 helps ensure network privacy by requiring a centrally designed, owned and operated access point to the transport network 105. In addition, integrators provide intelligent, low-cost direct routing of messages on a peer-to-peer basis. Also, employing standardized integrators as the access points to the transport network 105 simplifies the use of multiple internal systems by participants in the network. More specifically, conventional approaches to integration with systems or networks of other entities typically employ dedicated internal systems, connectors, or adapters. However, if a system failure occurs, or a primary connection is lost or congested, the entire internal system may be put under stress. The disclosed networking approach allows participants to easily employ their failsafe/backup systems in the event of a problem with the use of the disclosed integrator. Additionally, such redundant systems may also be continuously employed and that participant's traffic divided among its multiple systems to increase speed and overall efficiency, or traffic may be dynamically rerouted around problems. Integrators may detect patterns of malperformance and affect routing changes to bypass downed systems or components. Moreover, the integrators create a homologous network environment with simultaneous release updates and version control, and even provide guaranteed interoperability among the participants by employing single, standard formats and protocols, as well as standardized routing algorithms for message transmission and processing. Still further, the integrators provide a single, standardized system for logging various message and transmission data, providing that data to a central administrative location, and even receiving centralized rule changes that enable smooth transitions due to system changes.

Detailed Financial Services Network

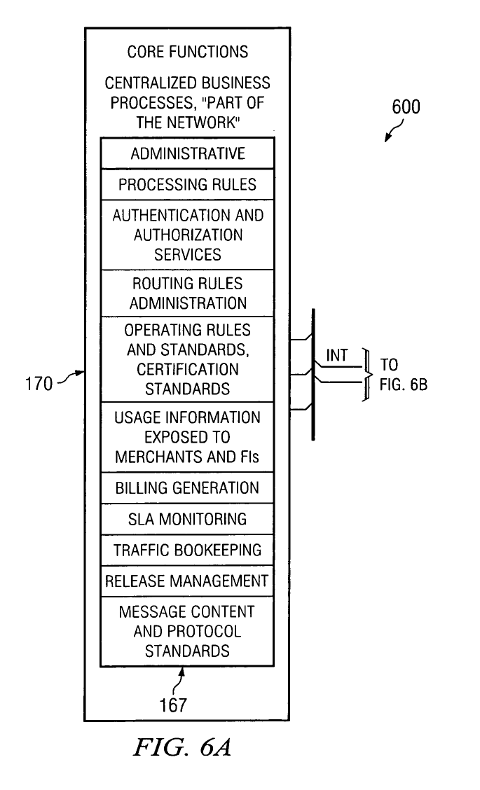

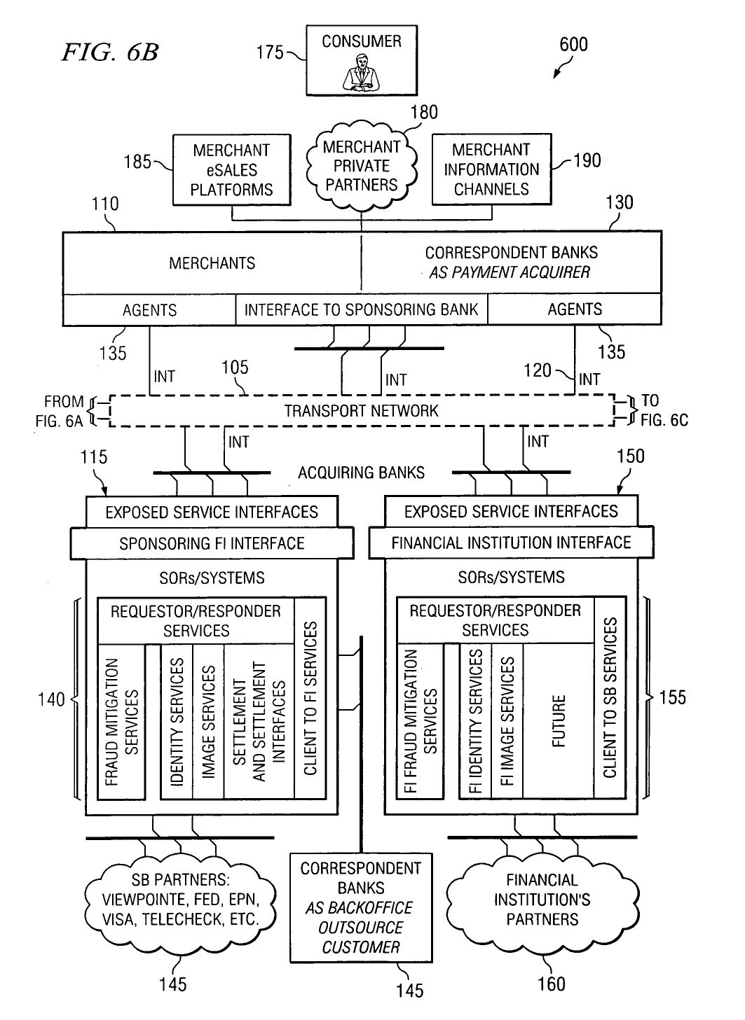

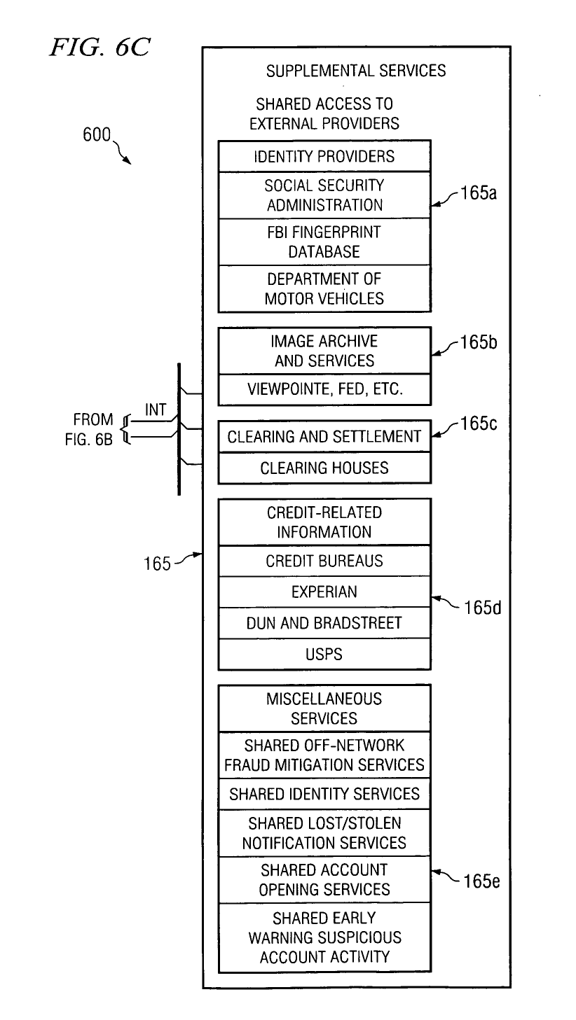

Turning now to FIG. 6, illustrated is a detail block diagram of one embodiment of a networked financial services network 600 revolving around the transport network 105 discussed with reference to FIGS. 1 to 5. As in FIG. 1, this more detailed embodiment still includes the participants (merchant 110, financial institutions 115, 150, external supplemental service providers 165) connected to the transport network 105, but now shown in greater detail. In addition, the core functions 170 area of the financial services network 600 is also illustrated, which includes the central administrator(s) 167 facilitating a host of administrative functions. Some examples include processing rules, authentication and authorization services, routing rules administration, operating rules and standards, certification standards for financial services network 600 components (e.g., interface adapters 305a, b and 530a, b configured to standards of the integrators 120), bookkeeping for participants and other users of the financial services network 600, SLA monitoring based on logs created by the integrators 120, traffic bookkeeping, release management, and message content and protocol standards. Of course, any type of administrative/core function or process may be implemented on the financial services network 600 and/or transport network 105 via the administrator(s) 167, and no limitation to any particular function or process is intended.

In this embodiment of the financial services network 600, a merchant 110 is again a participant of the transport network 105, and in this embodiment is connected to the transport network 105 in the same manner as a correspondent bank 130. A correspondent bank 130 may be any financial institution that desires the services provided by the transport network 105 but due to size or cost restrictions must contract with a point of entry in the network 105, such as through an agent 135 (which has an integrator 120). Thus, both the merchant 110 and correspondent bank 130 may each connect to the transport network 105 using an agent 135, and are physically connected to the transport network 105 using that agent's 135 integrator 120. Moreover, while an agent 135 provides the physical connection to the network 105, a sponsoring FI 115 (e.g., a sponsoring bank (SB)) provides the merchant 110 or other similarly situated entity messaging capabilities on the network 105. Thus, a sponsoring FI 115 is any type of financial institution that “sponsors” participation in the financial services network 600, for example, the merchant's 110 private bank. Non-participating entities therefore could not simply connect to the transport network 105 and try to retrieve desired information; rather, they employ sponsoring entities, as described above. Of course, the use of agents 135 is not required.

A sponsoring FI 115 may act as an “acquiring bank” (e.g., receiving payments for processing, etc.) for merchants 110 and correspondent banks 130 (or other entities) by sponsoring them as a participant in the transport network 105. The sponsoring FI 115, in the illustrated embodiment, receives the original request transmitted across the transport network 105 from the merchant's 110 (or correspondent bank's 130) agent 135. The sponsoring FI 115 may also include a number of internal systems 140, for example, SORs. The sponsoring FI's 115 internal systems 140 may be employed to provide specific services on an in-house basis for the bank's 115 internal use, for the bank's 115 customers (e.g., the merchant 110), or even for other entities or participants in the transport network 105. Examples of these services include, but are not limited to, fraud mitigation services, identity services, services associating with the processing of images, settlement services, and even services for another financial institution, such as financial institution 150 on which a draft may be drawn. Still further, the sponsoring FI 115 may also have an off-network, private connection, external to the transport network 105, to operating partners that can assist it in carrying out these services. These connections may also include internal connections to its own branch offices or locations, or its other datacenters, to process incoming deposits, check cashing, or other financial transactions, as discussed above.

Similarly, financial institution 150, in its role as a responder, may also have its own internal processing systems 155 (e.g., SORs) capable of providing services, such as fraud mitigation services, identity services, and the like. Moreover, financial institution 150 may also have its own private connections off of the transport network 105 with, for example, operating partners or branch offices 160 that can assist it in carrying out these services and other types of processing. As with all participants in the transport network 105, both the sponsoring FI 115 and financial institution 150 are connected to the transport network 105 via an integrator 120. As mentioned above, the financial services network 600 also again includes supplemental service providers 165 that provide services that may be “shared” (accessed/used) by all participants in the transport network 105. Supplemental service providers 165 are connected to the transport network 105, again via integrators 120. Such supplemental services may also be provided to sponsoring banks (e.g., FI 115), for example, to assist the sponsoring FI 115 in verification and guarantee services provided to the merchant 110, or even for the sponsoring bank's 115 own internal use.

Illustrated examples of these supplemental services include identity information providers 165a, such as the Social Security Administration, the FBI fingerprint database, and a state's Department of Motor Vehicles (DMV). Other types of supplemental services include image archives and services 165b for storage and access of image files, such as with the popular Viewpointe® system or the Federal Reserve System. Other supplemental services include clearing and settlement services 165c for financial items through clearing houses. Credit-related information 165d, such as credit bureaus, address information, such as from the U.S.P.S., and even specific providers of financial information like Dun & Bradstreet are also examples of available services. Still further examples of potential shared services 165 include a number of available shared miscellaneous services 165e provided to participants by third-parties, such as off-network fraud mitigation services (e.g., services provided using private networks not connected to the transport network 105), identity verification services, lost/stolen notification services, account opening services, and early warning suspicious account activity services. Of course, these are simply examples of potential supplemental services, and no limitation to any particular type of service or particular provider is intended.

The embodiment illustrated in FIG. 6 still further includes a consumer 175 whose attempted purchase from the merchant 110, or perhaps an attempted transaction with the correspondent bank 130 (e.g., a check cashing), will result in the transmission of messages between participants across the transport network 105. A merchant 110 may collaborate with its private partners 180 for available services, and sales to consumers 175 may be made through, for example, eSales platforms 185 of the merchant 110 (e.g., online purchasing through the merchant's 110 website) or other merchant 110 information or sales channels 190, such as POS terminals at a store or even mail orders. Of course, other types of transactions by the consumer 175 may also result in an exchange of information across the transport network 105, without limitation.

A primary role of the financial services network 600 is as a facilitator of business services by, for example, coordinating service delivery to participants via messages. The system's 600 administrative entity and components serve customer basic needs for monitoring information exchange and offer the centralized service management required to ensure a highly-available network is provided in a fashion that can adapt to changing needs and expanding services. To accomplish this, the financial services network 600 coordinates the private communications transport network 105 and employs standardized network integrators 120 for integration of each participant's specialized systems and networks with the transport network 105, while conforming to specifications managed by the administrators of the financial services network 600.

Intervening Requests in a Network Exchange

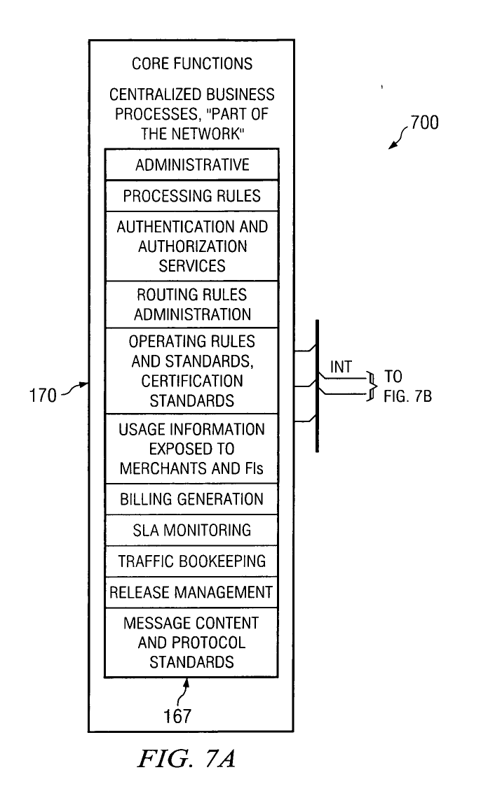

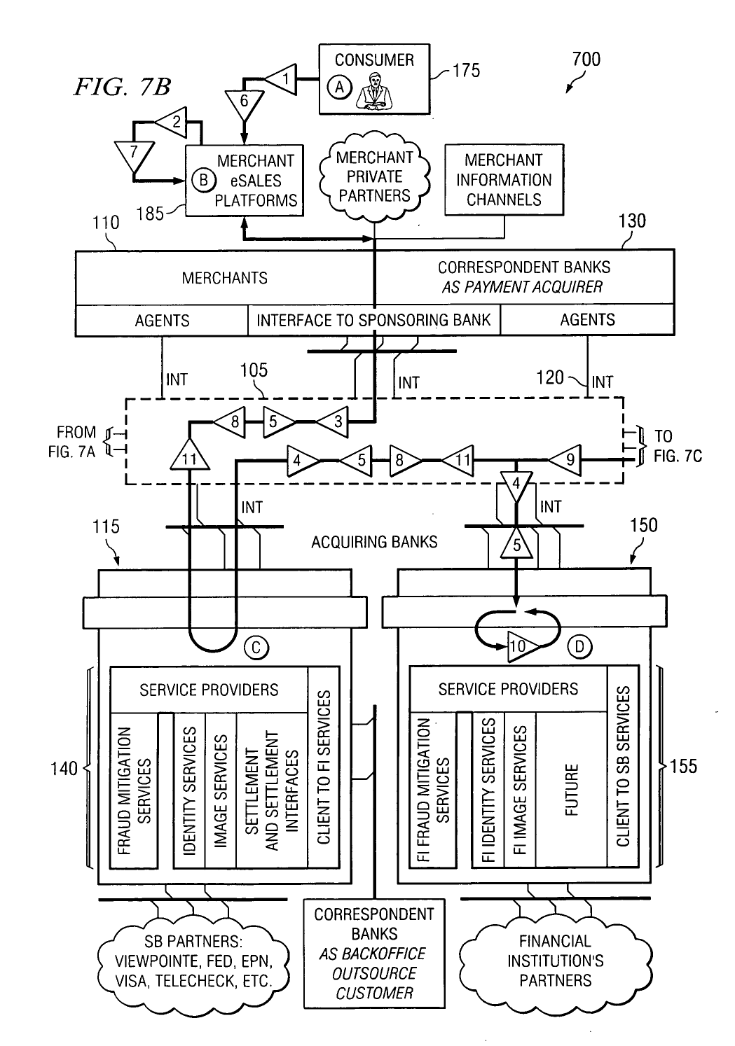

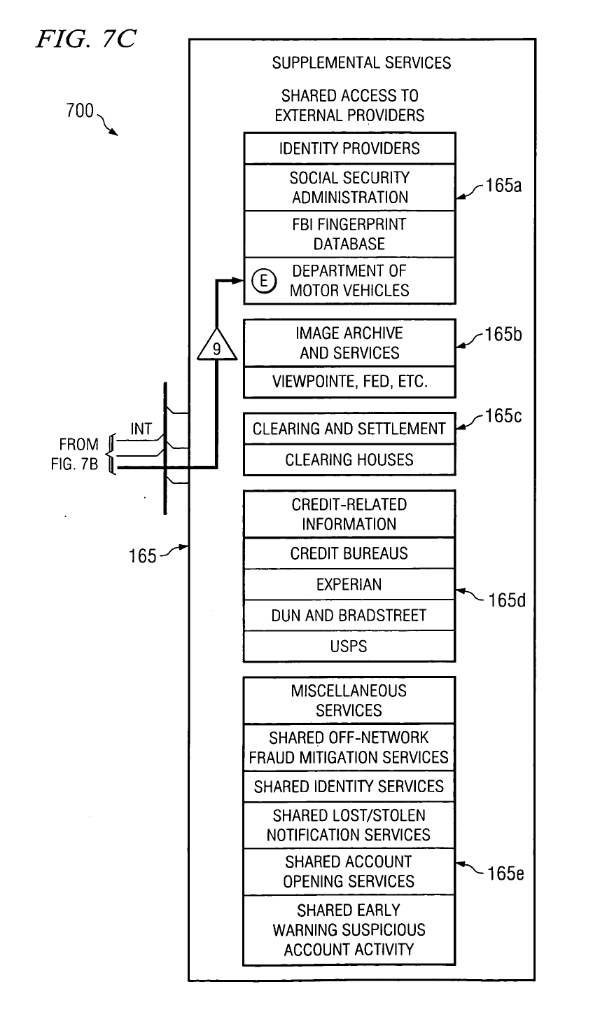

Turning now to FIG. 7, illustrated is an exemplary embodiment of a process flow 700 within the exemplary distributed financial services financial services network 600 shown in FIG. 6. The process flow illustrates that the financial services network 600 is capable of providing a number of different services to participants, and in this example provides fraud mitigation services and fund/transaction verification services using the transport network 105. Verification services may be provided as, for example, transaction verification or authentication, or even for a funds or transaction guarantee. In addition, fraud mitigation services may be provided to, for example, verify the identity of a consumer cashing a check or opening an account, or perhaps a loan or credit applicant. Other potential fraud mitigation services can include criminal history or prior fraudulent activity searches. Of course, the discussed examples are not exhaustive and other types of information, verification, or other financial services that may be provided using the distributed financial services financial services network 600 having the transport network 105.

The process 700 begins when a consumer 175 (entity A in this illustrated process) engages a merchant 110 for the purchase of goods or services through the merchant's 110 eSales platform 185 (entity B). Once the consumer 175 has found the goods or services he desires, he presents a check to the merchant 110 at the point of sale, although other forms of payment for the transaction, such as check conversions, automated clearing houses (ACH), electronic funds transfers (EFTs), or credit or debit cards, may also be employed. In this example, payment is tendered by check, so at the point of sale, information from the consumer's 175 check may be obtained, such as the MICR code off of the check, the transaction amount, and possibly supplemented with identifying information such as the consumer's 175 name and address. Once this information is captured, a message is sent to the merchant's 110 bank with a request, for example, a request for guarantee of funds or a guarantee of the transaction itself. The message may alternatively include a request for some type of fraud mitigation service to help ensure that the consumer 175 is not trying to defraud the merchant 110.

In this example, the sponsoring FI 115 (entity C) is the merchant's 110 bank and has been requested to guarantee the funds and the transaction. To make the guarantee request, the merchant's 110 internal system will capture the information mentioned above, and forward that information and the desired request to the integrator 120 affiliated with the merchant's 110 system, and which is connected to the transport network 105. In a preferred embodiment, the format of the message containing the information and request are converted by the merchant's 110 system to the network 105 standards before being sent to the integrator 120, as discussed above. Once the desired information and request are assembled in a message and sent to the integrator 120, that message is sent across the transport network 105 to the appropriate participant, which in this case is the merchant's financial institution (the sponsoring FI 115) for the desired response. The routing of each message (whether request or response) to the appropriate entity is typically handled in manner described above. Of course, as mentioned above, some variation may take place.

In one example, the check presented to the merchant 110 is drawn on another participating financial institution, financial institution 150 (entity D). Since the payment attempt is draw on a financial institution different than the sponsoring FI 115, the sponsoring FI 115 may then format its own request that is transmitted to financial institution 150 for financial institution 150 to provide whatever information FI 115 would like in order to determine if it should provide the desired guarantee of funds for the check. This request is generated in the sponsoring bank's 115 internal system, and then formatted to the standardized format of the integrator 120 and relayed by the integrator 120 across the transport network 105 to financial institution 150 for a response. Thus, the sponsoring FI 115 does not simply forward on the initial request it received, but rather it generates its own independent request (seeking a corresponding independent response) separate from the initial request it received. Therefore, such spontaneous generation of independent requests/responses are seen as pairs of intervening requests, and each participant in the network 105 is capable of generating their own intervening requests, if desired, in order to respond to a request made of it from another participant.

Turning briefly to FIG. 8, illustrated is a sequence diagram 800 showing the independence of intervening requests (and corresponding intervening responses) from an original request 810 sent by a first participant and a final response 820 to that original request. In this example, a first intervening request 830 is generated by a second participant due to the receipt of the original request 810, and while the original request is awaiting a response (e.g., in synchronous fashion). That intervening request 830 is then sent to a third participant in order to obtain information needed to respond to the original request 810. Then, when the first intervening request 830 is received by the third participant, it generates a second intervening request 840 that is sent to a fourth participant or perhaps a third-party provider for needed information. Once the fourth participant receives the second intervening request 840, it generates a second intervening response 850 and sends it back to the third participant. The third participant now generates a first intervening response 860 to the first intervening request 830 and sends it to the second participant. Now that the second participant has the needed information, which in this example is obtained from the first intervening response 860 (which was in turn generated based on information received in the second intervening response 850), it can now generate the response 820 to the original request 810 made of it. As may be seen by the sequence diagram 800, each successive response is typically delayed until an intervening response is received to a spontaneously generated request.

Thus, regardless of the type or destination of the requests made and sent by financial institution 150, once it receives responses to those requests, it can generate responses to requests made by the sponsoring FI 115. Of course, if financial institution 150 makes a decision internally, it could simply send a response without transmitting any requests of its own. After a response(s) is (are) received by the sponsoring FI 115, the received information may be processed internally, if needed. The processed results, or simply the received response if further processing is not required, are then the basis of a response from the FI 115 to the merchant 110 (or correspondent bank 130), in response to the original request. If a payment guarantee was originally requested, the final response back from the sponsoring FI 115 would either have that guarantee or not, typically based at least in part on the information that was provided by FI 150 via the intervening request.

Referring back now to FIG. 7, the sponsoring FI 115 may also employ its own agents to perform or otherwise handle the desired verifications and approvals. For example, FI 115 may contract with a third-party to determine what is needed to give an approval or guarantee, and that third-party entity could make the request to financial institution 150 or simply relay a request from one participant to another. Once the message is received via its own integrator 120, financial institution 150 then opens the message, processes the request, and responds to it, depending on what request is made of it. For example, if the original request is for FI 115 to guarantee the funds drawn by the consumer's 175 check, then financial institution 150 may receive an intervening request for certain account information, and then may make its own intervening requests regarding other information. All of this gathered information may then be used by FI 115 to determine if the guarantee should be made. In some embodiments, financial institution 150 will simply employ some of its internal resources and systems (e.g., database records it keeps) for verifying or determining account status, in addition to or in place of sending requests to external participants across the network 105.

If financial institution 150 has enough information to answer a request for information, it can do so and transmit a response back to the sponsoring FI 115. However, if further information is desired before the information requested of FI 150 can be given, financial institution 150 may employ, for example, some of the supplemental shared services 165 to gather its own information. For example, financial institution 150 may send its own intervening request message to the DMV (entity E), as illustrated, to perhaps verify identity information provided by the consumer 175. Such further information may also be the part of a fraud mitigation service, where the additional information is desired and used to help ensure that the consumer 175 is not attempting to defraud the merchant 110. In some embodiments, financial institution 150 may not yet have the information to give to the supplemental services 165, and thus financial institution 150 may send a message back to the sponsoring FI 115 with a qualified “No” response (a “No, But” response) to the verification request, where the “No” is qualified by stating that a different answer may be given if certain other information is provided. The additional information may be the driver's license number of the consumer 175. Of course, financial institution 150 could also send such a “No, But” response back to FI 115 even if it does not look to outside or supplemental resources for determining whether it can provide the requested information.

Once a “No, But” is received by the sponsoring FI 115, that FI 115 may then send its own “No, But” response back to the merchant 110 that gives a “No” to the original request, but also states that a different response may be the result if the driver's license number is provided. The merchant 110 can then obtain this information directly from the consumer 175. The merchant's 110 system would then send a new request to FI 115 similar to the original request, but also including the additional information (e.g., a drivers license number). The sponsoring FI 115 would then send a new request message to financial institution 150 including the additional information, and financial institution 150 would then send a new request message to the DMV providing the license information. Once the DMV verifies the information, the DMV would send a message back to financial institution 150 having a response to its request for identity verification. In another embodiment, financial institution 150 (or even Sponsoring FI 115) could cache the DMV information for subsequent requests within a given time frame to increase network efficiency and/or reduce payments to the DMV for information requests.

In addition to identity verification and/or fraud mitigation via the DMV, financial institution 115 may also send requests to other supplemental services, such as a credit bureau to determine the status of the consumer 175, if needed, or perhaps to a criminal database, such as the FBI fingerprint database, to determine if the consumer 175 has a criminal record or is perhaps wanted for prior alleged violations, such as for check fraud. Moreover, these supplemental services 165 may be used to store information that would normally be queried by a participating entity, perhaps as a backup in case that entity's internal systems become unavailable. Another use for the supplemental services 165 is as a replacement for conventional third-party database services that each participant may typically have to separately pay to access for gathering certain specific information. The transport network 105 can now provide access to such third-party information through a single avenue for all the entities involved. For example, the administrating body of the transport network 105 could form an agreement with certain supplemental services 165 such that all participants could access them. Such an agreement could then provide a volume discount that every participant in the transport network 105 enjoys, as well as a sharable connection point to access the supplemental services 165.

In yet another embodiment, such supplemental services 165 may even be employed as a double-check for certain transactions, for example, if a check for a very large amount is presented. For instance, merchants 110 would not typically mind bearing the risk on a $10 check, but a very large sum would usually create a desire for as much scrutiny as is practicable. Such an embodiment would be particularly useful in those situations where a bank on which a large check is drawn refuses to guarantee the funds to a depositing bank. The depositing bank may then quickly and efficiently employ more than one of these supplemental services 165 for a multiple transaction verification or authentication, as well as for providing fraud mitigation services. Such embodiments change the decision to “approve” the transaction from the drawing bank to the depositing bank such that the latter may make its own decision on the transaction. In yet other embodiments, the sponsoring FI 115 itself may send messages directly to providers of supplemental services 165, rather than to financial institution 150. Thus, the FI 115 could choose whether to approve a transaction based on the information it receives from the supplemental services 165, regardless of the response received from financial institution 150. Such an embodiment further illustrates the great flexibility of the disclosed systems and processes, such that any participants can determine both the type of information they would like to take into account to satisfy their individual requirements for a transaction, and whether it wants to approve a transaction on its own or see further information.

No matter what entity or entities are generating requests for verifications or guarantees, the disclosed systems and processes differ from conventional approaches in that they provide interactive responses based on interactive inquiries for information. More specifically, in conventional systems, such as the well-known Primary Payment System (PPS), a centralized database is typically accessed to determine if certain information, for example, personal account information, is available. However, such systems typically do not provide information in true interactive fashion. While the query on the database may be an interactive request, the information that is provided, or upon which a response is based, is not current. Generally speaking, such systems simply accumulate data at some regular interval, and that data is stored as “current” until the next batch of updates is provided. In contrast, in the disclosed systems and processes, since messages with requests are sent interactively to the actual information providers (or to participants who then send requests to the actual information providers) rather than a third-party information storage house, the actual access of information on which a response is based occurs interactively. Moreover, in such conventional data storage houses not only may the information be found to be stale or even incorrect, but since only certain information regarding only certain accounts (or the like) is selected to be stored, such data storage houses often have incomplete records. It would be impracticable, if not impossible, for such data storage houses to try to accumulate (and regularly update), every type of information available for every known account or record. In short, providing a conduit directly to the sources of such varied information in order to receive access to or a response based on that information interactively, is likely more efficient and accurate.

In addition, other types of conventional systems simply provide services for POS transaction, for example, only verifying whether an account is open in a debit card transaction. In contrast, the disclosed processes provide far more capability and flexibility, such as fund guarantees and transaction guarantees, as well as an almost infinite number of fraud mitigation services, which translates into more security for all participants. In addition, conventional systems are typically limited to a single type of transaction verification, such as inquiring into only checking account information when the transaction involves a check. However, the present processes are flexible enough to allow almost any type of request to be created and transmitted to the appropriate entity, including inquiries that would typically not be made for certain types of transactions. For example, if a check transaction is involved, the disclosed systems and processes can facilitate requests that go far beyond the typical fund guarantees associated with check transactions. Examples include, but are not limited to, accessing criminal records or fingerprint databases, or even simply the address of the account holder in an effort to reduce the chance of fraud, and comparing more detailed (e.g., multiple factor) data with that known at the sponsoring FI 115.

Accounting for System Usage

By providing the distributed financial services system disclosed herein, as well as the numerous processes that are available through the disclosed system, accounting systems and processes may be integrated into the core functions 170 of the system. Such accounting systems and processes will allow system usage to be monitored and tracked, and thus eventually billed to the participants. These accounting systems may be embodied in software applications and modules, hardware components, or a combination of both, and no limitation to any particular embodiment is intended. Moreover, these accounting systems and processes may be implemented through one or more of the administrators 167 discussed above, however, dedicated components to implement these practices are also envisioned. Furthermore, one or more of such accounting systems or processes may even be out-sourced to third-parties outside of the network, or may be entirely implemented within the system.

Examples of accounting services that may be implemented on the system are customer support centers, a billing department, bookkeeping, usage tracking and monitoring, troubleshooting logs, and the like. Most or all of these types of accounting records may be generated based on the activity logs captured at each participants integrator 120 (see FIG. 4A). At periodic times, each integrator may transmit data from its log to the administrator 167 so that accounting and other auditing services can be performed. Billing for participant usage of the system may be based on, for example, each participant's data transport across the transport network 105. In addition, specific charges may be derived from a pricing table, based on message volume, message size, or other criteria.

Furthermore, inter-participant fee notification statements may also be generated using the accounting services. Such fee statements are net-based usage statements sent to participants that set forth what one participant owes another participant for services consumed. More specifically, when a participant makes a request of another participant across the network 105, that usage is typically logged and then billed to that participant. If that request is sent to a second participant, the transmission of a response back to the first participant is also logged. However, if the second participant later sends its own request across the network 105 to the first participant, the requests are simply net-balanced at the end of each bookkeeping cycle between the participants. Thus, this net-difference approach has the charges between two participants netted to determine which one owes more; then, that participant's statement can reflect the net amount due to the other participant. Yet another potential bookkeeping scheme is to adjust net usage charges based on the quality of service provided by each participant. In this scheme, if a participant does not comply with terms of his SLA, for example, takes 3 seconds to respond to a request rather than the 2 second required by the SLA, that participant might not get a net credit against the party making the request since the response was unacceptably delayed. In essence, therefore, that participant is not getting paid for the request made of him because of the delay in responding, even if the requesting party still employs and benefits from the information gathered in the delayed response. As a result, participants have an incentive to maintain a high quality of service when responding to requests from other participants. Of course, other creative bookkeeping schemes for handling message transmission billing and inter-participant fee notifications are possible, and no limitation to any particular approach is intended.

While various embodiments of a networked distributed financial services systems according to the principles disclosed herein have been described above, it should be understood that they have been presented by way of example only, and not limitation. Thus, the breadth and scope of the invention(s) should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 CFR 1.77 or otherwise to provide organizational cues. These headings shall not limit or characterize the invention(s) set out in any claims that may issue from this disclosure. Specifically and by way of example, although the headings refer to a “Technical Field,” such claims should not be limited by the language chosen under this heading to describe the so-called technical field. Further, a description of a technology in the “Background” is not to be construed as an admission that technology is prior art to any invention(s) in this disclosure. Neither is the “Brief Summary” to be considered as a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

What is claimed is:

1. A distributed financial services system, comprising:
a transport network for the transmission of messages thereacross regarding services associated with financial transactions;
a plurality of network integrators each connected to the transport network and configured to send and receive the messages across the transport network on behalf of entities connected to the transport network via corresponding network integrators, the plurality of network integrators using standardized message and transmission formats and protocols for the generating, sending and receiving the messages; and
a network administrator connected to the transport network via one of the plurality of network integrators and configured to facilitate and govern the transmission of the messages across the transport network directly between the plurality of network integrators.

2. A distributed financial services system according to claim 1, further comprising a plurality of interface adapters associated with corresponding entities and in communication with corresponding network integrators, wherein each of the plurality of interface adapters is configured to:
translate requests or responses generated by its corresponding entity to the standardized message format,
forward the translated requests or responses to its corresponding network integrator for generating a message based on the forwarded requests or responses, and
receive requests or responses from its corresponding network integrator, the received requests or responses extracted from messages received by the corresponding network integrator across the transport network.

3. A network integrator providing a participant access to a transport network used for transmitting a message thereacross regarding services associated with financial transactions, the network integrator comprising:
a message relay module configured to receive requests or responses from the participant, and to generate the message based on the request or response;
an administrative tasks module configured to determine a direct transmission path of the message to a second network integrator connected to the transport network; and
a message relay/receiver module configured to send the message to the second network integrator using message and transmission formats and protocols standard to the network integrators.

4. A network integrator according to claim 3, wherein:
the relay/receiver module is further configured to receive a message having requests or responses from a second participant sent via the second network integrator using message and transmission formats and protocols standard to the network integrators;
the administrative tasks module is further configured to log receipt of the message; and
the message relay module is further configured to send the requests or responses in the message to the first participant.

5. A method of communicating messages across a transport network, the method comprising:
receiving, at a first network integrator connected to the transport network, requests or responses from a first participant, the requests or responses regarding services associated with financial transactions;
generating a message based on the request or response with the first integrator;
determining with the first integrator a direct transmission path of the message to a second network integrator connected to the transport network;
transmitting the message to the second network integrator via the transport network using message and transmission formats and protocols standard to the network integrators;
receiving the message at the second network integrator;
extracting the requests or responses from the message using the second network integrator; and
sending the requests or responses to a second participant associated with the second network integrator.

6. A method according to claim 5, further comprising:
creating an intervening request by the second participant based on a received original request message from the first network integrator participant, the original request message comprising an original request from the first participant and awaiting a final response;
sending the intervening request to the second network integrator;
generating an intervening request message based on the intervening request with the second network integrator, and transmitting the intervening request message to a third network integrator via the transport network using the standardized message and transmission formats and protocols;
receiving an intervening response message at the second network integrator from the third network integrator, and extracting an intervening response from the intervening response message using the second network integrator, the intervening response answering the intervening request;
sending the intervening response to the second participant, the second participant generating the final response to the original request from the first participant based on the intervening response and sending the final response to the second network integrator; and
transmitting a final response message from the second network integrator to the first network integrator via the transport network using the standardized message and transmission formats and protocols, the final response message comprising the final response answering the original request.

7. A method of communicating messages across a transport network, the method comprising:
receiving a first request from a first participant at a first integrator connected to the transport network, the first request regarding services associated with financial transactions;
generating a first request message based on the first request with the first integrator, and transmitting the first request message to a second integrator via the transport network;
extracting the first request from the first request message using the second integrator, and sending the first request to a second participant associated with the second integrator;
generating a first response to the first request comprising a answer and a qualifying statement, the qualifying statement providing that a different answer may be generated if a second request contained additional information;
sending the first response to the second integrator for generating a first response message based on the first response with the second integrator, and transmitting the first response message to the first integrator via the transport network;
extracting the first response from the first response message using the first integrator, and sending the first response to the first participant;
generating a second request by the first participant, the second substantially similar to the first request and further comprising the additional information;
sending the second request to the first integrator for generating a second request message based on the second request, and transmitting the second request message to the second integrator via the transport network;
extracting the second request from the second request message using the second integrator, and sending the second request to the second participant;
generating a second response to the second request based on the first request and the additional information, the second response comprising an answer different from the first response;
sending the second response to the second integrator for generating a second response message based on the second response, and transmitting the second response message to the first integrator via the transport network; and
extracting the second response from the second response message using the first integrator, and sending the second response to the first participant.

8. A method of prioritizing transmission of messages containing requests or responses regarding services in financial transactions across a network, the method comprising:
providing a message containing an immediate request regarding a first financial transaction in need of an immediate response to the immediate request in order to be completed;
providing a message containing a nonimmediate request regarding a second financial transaction not in need of an immediate response to the nonimmediate request in order to be completed;
designating the immediate request and immediate response as high priority, and designating the nonimmediate request and nonimmediate response as low priority; and
transmitting the request and response designated high priority before transmitting the request and response designated low priority such that the first financial transaction is completed before the second transaction.
